(19) United States
(12) Patent Application Publication
(10) Pub. No.: US 2026/0350959 A1
(43) Pub. Date: Nov. 5, 2026

(54) GENERATING LOCALIZED, AND FLEXIBLE IMAGE CAPTIONS USING NEURAL NETWORKS

(71) Applicant: GOOGLE LLC, Mountain View, CA (US)

(72) Inventors: Debidatta Dwibedi, Sunnyvale, CA (US); Jonathan Tompson, San Carlos, CA (US); Andrew Zisserman, London (GB); Yusuf Aytar, London (GB)

(21) Appl. No.: 19/487,224

(22) PCT Filed: May 23, 2024
(86) PCT No.: PCT/US2024/030879

§ 371 Date: Nov. 24, 2025

Related U.S. Application Data
(60) Provisional application No. 63/468,502, filed on May 23, 2023.

(51) Int. Cl. G06V 10/25; G06V 10/82; G06V 20/70

(52) U.S. Cl. CPC G06V 10/25; G06V 10/82; G06V 20/70

(57) ABSTRACT

Methods, systems, and apparatus, including computer programs encoded on a computer storage medium, comprising: obtaining an input image; processing the input image using an image encoder neural network that has been trained to process the input image to generate an image sequence of image embedding vectors characterizing the input image; obtaining data specifying a location of a first bounding box within the input image that depicts a first object; generating a bounding box embedding vector that represents the location of the first bounding box; generating an input sequence of input embedding vectors that includes the image sequence of image embedding vectors and the bounding box embedding vector; and processing the input sequence of input embedding vectors using a language model neural network to generate as output an output sequence of text tokens that represents a text caption that describes the first object depicted within the first bounding box.

### CROSS-REFERENCE TO RELATED APPLICATION

This application claims the benefit of U.S. Application No. 63/468,502, filed on May 23, 2023, which is incorporated herein by reference

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs an image captioning task using an image encoder neural network and a language model neural network.

Throughout this specification, an “embedding” can refer to an ordered collection of numerical values, e.g., a vector, matrix, or other tensor of numerical values.

According to one aspect, there is provided a method performed by one or more computers, the method comprising: obtaining an input image; processing the input image using an image encoder neural network that has been trained to process the input image to generate an image sequence of image embedding vectors characterizing the input image; obtaining data specifying a location of a first bounding box within the input image that depicts a first object; generating a bounding box embedding vector that represents the location of the first bounding box; generating an input sequence of input embedding vectors that includes the image sequence of image embedding vectors and the bounding box embedding vector; and processing the input sequence of input embedding vectors using a language model neural network to generate as output an output sequence of text tokens that represents a text caption that describes the first object depicted within the first bounding box.

In some implementations, the method further comprises receiving an input specifying a target length for the text caption; and generating a length embedding that represents the target length; wherein the input sequence of input embedding vectors includes (i) the image sequence of image embedding vectors, (ii) the bounding box embedding vector, and (iii) the length embedding that represents the target length.

In some implementations, the target length is a target number of text tokens for the output sequence of text tokens.

In some implementations, the method further comprises processing the input image using an object detector neural network to identify the location of the first bounding box within the input image.

In some implementations, the method further comprises obtaining data specifying a location of a second bounding box within the input image that depicts a second object; generating a second bounding box embedding vector that represents the location of the second bounding box; generating a second input sequence of input embedding vectors that includes the image sequence of image embedding vectors and the second bounding box embedding vector; and processing the second input sequence of input embedding vectors that using the language model neural network to generate as output an output sequence of text tokens that represents a text caption that describes the second object depicted within the second bounding box.

In some implementations, generating a bounding box embedding vector that represents the location of the first bounding box comprises: processing the data specifying a location of a first bounding box using a linear neural network to generate a one-dimensional vector describing the location of the first bounding box within the input image.

In some implementations, the data specifying a location of a first bounding box comprises the coordinates of the first bounding box.

In some implementations, processing the input image using an image encoder neural network that has been trained to process the input image to generate an image sequence of image embedding vectors characterizing the input image comprises: generating a set of initial image embedding vectors using an embedding layer of the image encoder neural network, wherein each initial image embedding vector is derived at least in part from a corresponding patch in the input image; and processing the set of initial image embedding vectors using a plurality of neural network layers, including one or more self-attention neural network layers, to generate a set of final image embedding vectors.

In some implementations, the method further comprises: an input specifying a second target length for the text caption; generating a second length embedding that represents the second target length; and processing a third input sequence of input embedding vectors that includes the image sequence of image embedding vectors, the bounding box embedding vector, and the second length embedding that represents the second target length using the language model neural network to generate as output a second output sequence of text tokens that represents a second text caption that describes the first object depicted within the first bounding box.

In some implementations, the image encoder neural network and the language model neural network are jointly trained to optimize an objective function that measures the performance of the image encoder neural network and the trained language model neural network on a next token prediction task.

In some implementations, the linear neural network is jointly trained along with the image encoder neural network and the trained language model neural network.

In some implementations, the language modeling neural network is an auto-regressive Transformer-based neural network comprising a plurality of layers that each apply a self-attention operation.

In some implementations, the image encoder neural network comprises a convolutional neural network.

In some implementations, the convolutional neural network is configured to process the input image to generate an output tensor characterizing the input image, and wherein the image encoder neural network is configured to map the output tensor to the image sequence of image embedding vectors.

According to another aspect, there is provided a method performed by one or more computers, the method comprising: obtaining an input image; processing the input image using an image encoder neural network that has been trained to process the input image to generate an image sequence of image embedding vectors characterizing the input image; obtaining data specifying a location of a first bounding region within the input image that depicts a first object; generating a bounding region embedding vector that represents the location of the first bounding region; generating an input sequence of input embedding vectors that includes the image sequence of image embedding vectors and the bounding region embedding vector; and processing the input sequence of input embedding vectors using a language model neural network to generate as output an output sequence of text tokens that represents a text caption that describes the first object depicted within the first bounding region.

In some implementations, the method further comprises receiving an input specifying a target length for the text caption; and generating a length embedding that represents the target length; wherein the input sequence of input embedding vectors includes (i) the image sequence of image embedding vectors, (ii) the bounding region embedding vector, and (iii) the length embedding that represents the target length.

In some implementations, the target length is a target number of text tokens for the output sequence of text tokens.

In some implementations, the method further comprises processing the input image using an object detector neural network to identify the location of the first bounding region within the input image.

In some implementations, the method further comprises: obtaining data specifying a location of a second bounding region within the input image that depicts a second object; generating a second bounding region embedding vector that represents the location of the second bounding region; generating a second input sequence of input embedding vectors that includes the image sequence of image embedding vectors and the second bounding region embedding vector; and processing the second input sequence of input embedding vectors that using the language model neural network to generate as output an output sequence of text tokens that represents a text caption that describes the second object depicted within the second bounding region.

In some implementations generating a bounding region embedding vector that represents the location of the first bounding region comprises: processing the data specifying a location of a first bounding region using a linear neural network to generate a one-dimensional vector describing the location of the first bounding region within the input image.

In some implementations, the data specifying a location of a first bounding region comprises the coordinates of the first bounding region.

In some implementations, the method further comprises: receiving an input specifying a second target length for the text caption; generating a second length embedding that represents the second target length; and processing a third input sequence of input embedding vectors that includes the image sequence of image embedding vectors, the bounding region embedding vector, and the second length embedding that represents the second target length using the language model neural network to generate as output a second output sequence of text tokens that represents a second text caption that describes the first object depicted within the first bounding region.

According to another aspect, there is provided a system comprising: one or more computers; and one or more storage devices communicatively coupled to the one or more computers, wherein the one or more storage devices store instructions that, when executed by the one or more computers, cause the one or more computers to perform operations of methods described herein.

According to another aspect, there are provided one or more non-transitory computer storage media storing instructions that when executed by one or more computers cause the one or more computers to perform operations of methods described herein.

The subject matter described in this specification can be implemented in particular embodiments so as to realize one or more of the following advantages.

By incorporating a bounding box embedding vector along with image embeddings as part of an input to a language model neural network, the system can effectively generate localized captions for the portion of the image that is depicted within the bounding box. The utility and/or fidelity, for example, of an image classification output by the system can be improved through this process. Moreover, by ensuring emphasis is placed on a portion of the image, an improved result can be achieved for given computing resources.

Moreover, when a length embedding is used, the described techniques allow the system to controllably generate a full spectrum of captions ranging from short object names to full sentence descriptions. Thus, the described techniques allow a single model to perform multiple tasks that require generating different types or amounts of text for a given image, e.g., by performing two or more of object recognition, localized dense captioning, and full image captioning.

As a particular example, the system can receive a target length of 1 word when performing an object classification task. As another example, the system can receive a target length of 5 words when performing an attribute recognition task. Similarly, the system can receive a target length of 10 words when performing a captioning task where it is important to take the context of an image into account.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example caption generation system.

FIG. 2 is a flow diagram of an example process for performing caption generation.

FIG. 3. is a flow diagram of an example process for jointly training an image encoder neural network and a language model neural network of a caption generation system.

FIG. 4 shows an example of an input image and associated captions generated by a caption generation system

FIG. 5 illustrates an example of a system for performing zero-shot visual question answering.

FIG. 6 shows an example of training a caption generation system.

FIG. 7 illustrates an example process for generating a set of training data for a caption generation system.

FIG. 8 illustrates another an example system for performing zero-shot visual question answering.

Like reference numbers and designations in the various drawings indicate like elements.

### DETAILED DESCRIPTION

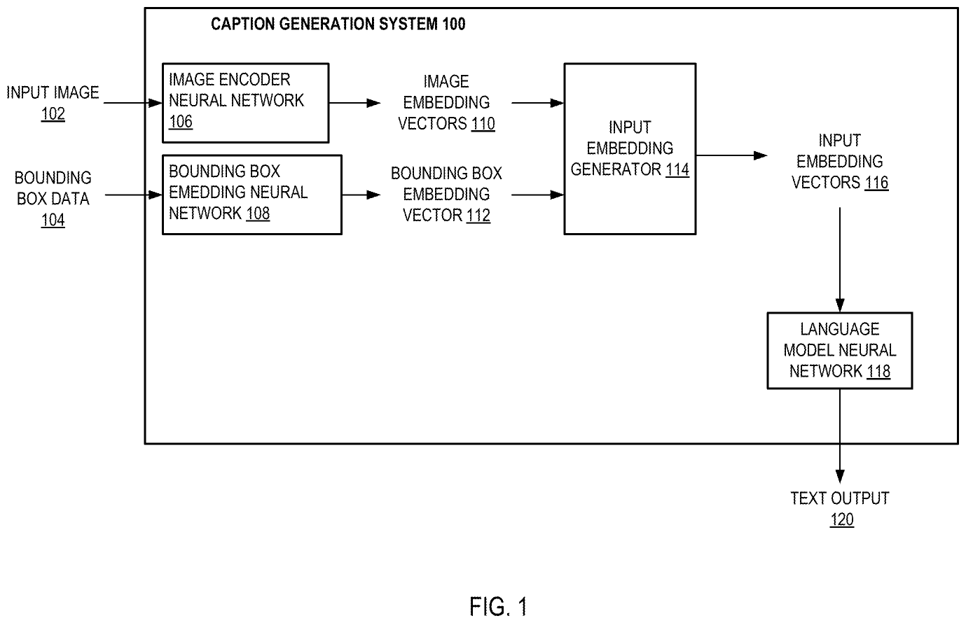

FIG. 1 shows an example caption generation system 100. The caption generation system 100 is an example of a system implemented as computer programs on one or more computers in one or more locations in which the systems, components, and techniques described below are implemented.

The caption generation system 100 includes an image encoder neural network 106, a bounding box embedding neural network 108, an input embedding generator 114, and a language model neural network 118.

The caption generation system 100 is configured to process an input image 102, i.e., to process the intensity values of the pixels of the image 102, and a set of bounding box data 104 to generate a text output 120.

The input image 102 can be generated using any appropriate imaging device, e.g., a camera, a microscopic imaging device, a telescopic imaging device, a medical imaging device (e.g., a computed tomography (CT) imaging device, an x-ray imaging device, or an ultrasound (US) imaging device), etc. The input image 102 can show (depict) one or more objects. For instance, an image captured by a camera can show objects such as road signs, vehicles, pedestrians, buildings, etc. As another example, an image captured by a medical imaging device can show anatomical structures (e.g., organs, tumors, etc.), tissues, regions of a human or animal body, etc.

The bounding box data 104 can specify the location of a first bounding box in the image that depicts an object. The bounding box data 104 can represent a bounding box as box coordinates. More specifically, the data 104 specifying the location of a first bounding box can be the coordinates of the first bounding box, e.g., the coordinates of the four corners of the bounding box, the coordinates of two of the four corners of the bounding box, or the coordinates of the center of the bounding box and a height and width of the bounding box. In general, a bounding box may be rectilinear (e.g. a square or a rectangle) but may also take an alternative shape, whether regular or irregular; the skilled person will recognize that appropriate data 104 can define the extent of such a region. The region of the image encompassed by the bounding box may be understood as a bounding region; where reference is made to the location of a bounding box in the description below it will be understood that the process can also be understood as applying to the location of the bounding region. Similarly, a bounding box embedding neural network or bounding box embedding vector can refer to bounding region embedding neural network or a bounding region embedding vector.

The text output 120 can be an output sequence of text tokens that represents a text caption that describes the object depicted within the bounding box or bounding region.

The image encoder neural network 106 processes an input image 102 to generate an image sequence of image embedding vectors characterizing the input image.

The image sequence of image embedding vectors 120 can include any appropriate number of image embeddings, e.g., a static (predefined) number of image embedding vectors, or a number of image embedding vectors that depends on the input image 102.

The image encoder neural network 106 can have any appropriate neural network architecture, e.g., including any appropriate types of neural network layers (e.g., attention layers, convolutional layers, fully-connected layers, etc.) in any appropriate number (e.g., 5 layers, 10 layers, or 20 layers) and connected in any appropriate configuration (e.g., as a directed graph of layers). In some examples, the image encoder neural network can be a convolutional neural network. In some examples, the image encoder neural network 106 can be a vision transformer neural network e.g., SoViT, CrossViT, and so on.

When the image encoder neural network 106 includes a convolutional neural network, the convolutional neural network can be configured to process the input image to generate an output tensor characterizing the input image. The image encoder neural network 106 can be configured to map the output tensor to the image sequence of image embedding vectors.

The bounding box embedding neural network 108 is configured to process the bounding box data 104 specifying a location of a first bounding box within the input image 102 that depicts a first object to generate a bounding box embedding vector 112. The bounding box embedding neural network 108 can generally have any appropriate neural network architecture, e.g., including any appropriate types of neural network layers (e.g., attention layers, convolutional layers, fully-connected layers, etc.) in any appropriate number (e.g., 5 layers, 10 layers, or 20 layers) and connected in any appropriate configuration (e.g., as a directed graph of layers). As a particular example, the neural network 108 can be a linear neural network that includes one or more linear layers.

The bounding box embedding vector 112 represents the location of the first bounding box (alternatively considered as the location of the first bounding region). That is, the bounding box embedding vector 112 is a vector describing the location of the first bounding box or first bounding region within the input image.

In some examples, the caption generation system 100 can process the input image using an object detector neural network to identify the location of the first bounding box within the input image. For example, the system 100 can process the image using an object detector neural network to generate bounding boxes for each object depicted in the image and the system 100 or a user can select the first bounding box from the bounding boxes identified in the object detection output.

The object detector neural network can have any appropriate neural network architecture, e.g., including any appropriate types of neural network layers (e.g., attention layers, convolutional layers, fully-connected layers, etc.) in any appropriate number (e.g., 5 layers, 10 layers, or 20 layers) and connected in any appropriate configuration (e.g., as a directed graph of layers). As a particular example, the object detector neural network can have an OWL-ViT architecture.

The input embedding generator 114 processes the image sequence of image embedding vectors 110 and the bounding box embedding vector 112 to generate an input sequence of input embedding vectors 116 that includes the image sequence of image embedding vectors and the bounding box embedding vector.

The language model neural network 118 is configured to process the input sequence of input embedding vectors 116 that includes the image sequence of image embedding vectors 110 and the bounding box embedding vector 112 to generate as output an output sequence 120 of text tokens that represents a text caption that describes the first object depicted within the bounding box. For example, if the bounding box depicts a basketball on a chair, the text caption can read “A basketball” or “A basketball on a chair”.

Although only one language model neural network 118 is depicted in FIG. 1, the language model neural network 118 can represent a set of multiple language models that can each be specially configured to perform certain tasks.

For example, as described in more detail below, the set of language models represented by language model neural network 118 can include a large language model (“LLM”) that is configured to process an input sequence of embeddings and generate text tokens that represent a text caption.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code. For brevity, large language models are also referred to herein as “language models.”

The language model neural network 118 can be any appropriate neural network that receives an input sequence made up of text tokens selected from a vocabulary and auto-regressively generates an output sequence made up of text tokens from the vocabulary. For example, the language model neural network can be a Transformer-based language model neural network or a recurrent neural network-based language model neural network.

In some situations, the language model neural network 118 can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the language model neural network can process the current input sequence to generate a score distribution (e.g., a probability distribution) that assigns a respective score, e.g., a respective probability, to each token in the vocabulary of tokens. The language model neural network can then select, as the particular token, a token from the vocabulary using the score distribution. For example, the neural network of the language model can greedily select the highest-scoring token or can sample, e.g., using nucleus sampling or another sampling technique, a token from the distribution.

For example, the language model neural network 118 can be a text decoder neural network. The text decoder neural network can be auto-regressive Transformer-based neural network that includes several (e.g., 10, 12, 15, etc.) layers that each apply a self-attention operation.

As a particular example, the language model neural network 118 can be an auto-regressive Transformer-based neural network that includes (i) a plurality of attention blocks that each apply a self-attention operation and (ii) an output subnetwork that processes an output of the last attention block to generate the score distribution.

The language model neural network 118 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl. A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. ar Xiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

In some examples, the caption generation system 100 can also receive an input specifying a target length for a text caption to be generated by the system 100 and generate a length embedding that represents the target length.

The language model neural network 118 can then process an input sequence of input embedding vectors that includes the image sequence of image embedding vectors, the bounding box embedding vector and the length embedding to generate as output an output sequence of text tokens that represents a text caption that describes the first object depicted within the bounding box, where the text caption is of the target length. For example, a bounding box in an image can depict a giraffe eating leaves next to a baseball. If the target length is 5 text tokens, the caption can read “A giraffe and a baseball”. If the target length is 2, the caption can read “A giraffe” and similarly, if the target length is 3, the caption can read “A giraffe eating”. The caption generation system 100 can obtain the target length from, for example, a user or from another system.

When a length embedding is used, the caption generation system 100 can controllably generate a full spectrum of captions ranging from short object names to full sentence descriptions. This allows a single caption generation system to perform multiple tasks that require generating different types or amounts of text for a given image, e.g., by performing two or more of object recognition, localized dense captioning, and full image captioning.

So that the system can effectively condition the language model on a representation of the input image, each image embedding vector in the image sequence of image embedding vectors 110 has the same dimensionality as the text embedding vectors that represent the text tokens from the vocabulary of text tokens.

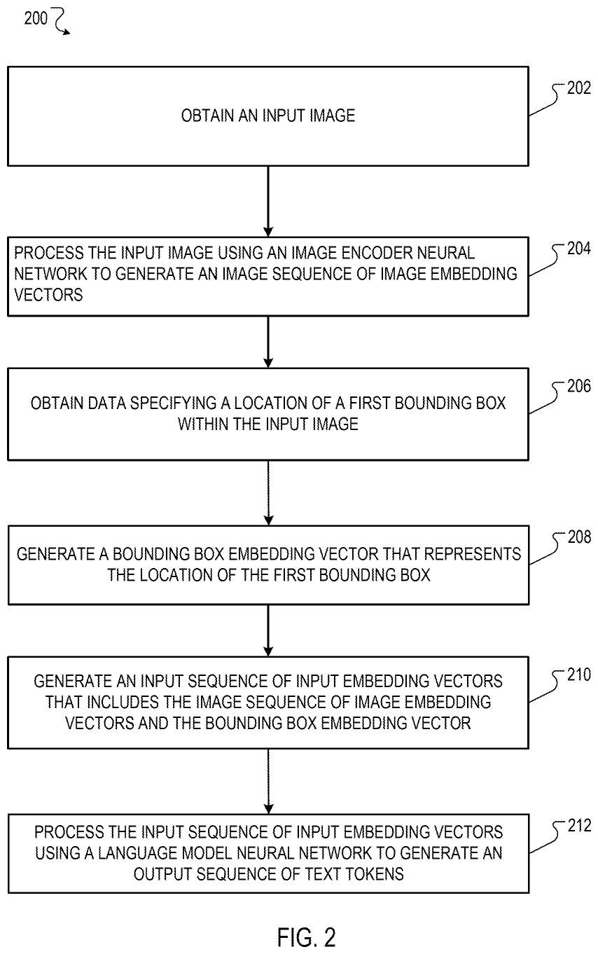

FIG. 2 is a flow diagram of an example process 200 for performing caption generation. For convenience, the process 200 will be described as being performed by a system of one or more computers located in one or more locations. For example, a caption generation system, e.g., the caption generation system 100 of FIG. 1, appropriately programmed in accordance with this specification, can perform the process 200.

The system can obtain an input image (step 202). The input image can depict one or more objects. For instance, an image captured by a camera can show objects such as road signs, vehicles, pedestrians, buildings, etc. As another example, an image captured by a medical imaging device can show anatomical structures (e.g., organs, tumors, etc.), tissues, regions of a human or animal body, etc.

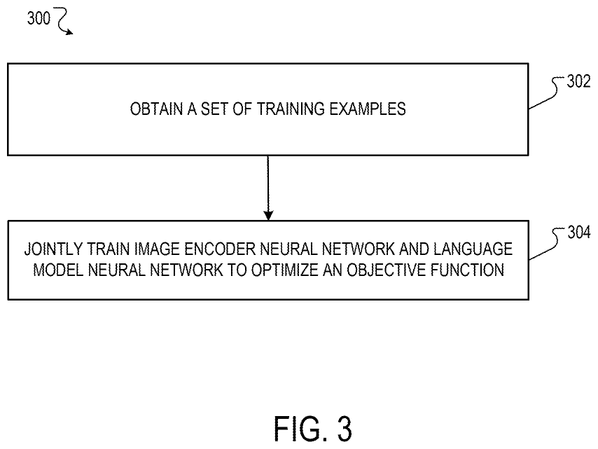

The system can process the input image using an image encoder neural network (step 204). The image encoder neural network can be trained to process the input image to generate an image sequence of image embedding vectors. The image embedding vectors can characterize the input image. Training the image encoder neural network is described in further detail below with reference to FIG. 3.

Generally, each of the image embedding vectors corresponds to a respective region within the input image. The image sequence of image embedding vectors can include any appropriate number of image embeddings, e.g., a static (predefined) number of image embedding vectors, or a number of image embedding vectors that depends on the input image.

The system can first generate a set of initial image embedding vectors using an embedding layer of the image encoder neural network. In particular, the system can divide the image into a grid of patches. Each initial image embedding vector can be derived at least in part from a corresponding patch in the input image. When the neural network is a Transformer-based neural network, the system can then process the set of initial image embedding vectors using several neural network layers, including one or more self-attention neural network layers, to generate a set of final image embedding vectors.

The system can obtain data specifying a location of a first bounding box within the input image that depicts a first object (step 206). The data can specify the location of an a first bounding box in the image that depicts an object. The data can represent a bounding box as box coordinates. More specifically, the data specifying the location of a first bounding box can the coordinates of the first bounding box. This data can be understood to define the location of a first bounding region encompassed by the bounding box.

In some examples, the caption generation system can process the input image using an object detector neural network to identify the location of the first bounding box within the input image.

The system can generate a bounding box embedding vector (step 208). The bounding box embedding vector can represent the location of the first bounding box (alternatively considered as the location of the first bounding region).

For example, the system can use a linear neural network to generate a bounding box embedding vector that represents the location of the first bounding box. The bounding box embedding vector can be a one-dimensional vector describing the location of the first bounding box within the input image.

The system can generate an input sequence of input embedding vectors that includes the image sequence of image embedding vectors and the bounding box embedding vector (step 210).

The system can process the input sequence of input embedding vectors using a language model neural network to generate an output sequence of text tokens that represents a text caption (step 212). The text caption can describe the first object depicted within the first bounding box. For example, if the bounding box depicts a basketball on a chair, the text caption can read “A basketball” or “A basketball on a chair”.

In some implementations, the system can receive an additional input specifying a target length for the text caption. The target length can be a target number of total text tokens in the output sequence of text tokens.

The system can generate a length embedding that represents the target length. The system can generate a prefix token that represents the target length for an output caption i.e., LENGTH-1, LENGTH-6, LENGTH-8, and so on.

The input sequence of input embedding vectors for the large language model can include the image sequence of image embedding vectors, the bounding box embedding vector, and the length embedding that represents the target length.

The language model neural network can then process the input sequence of input embedding vectors to generate an output sequence of text tokens that represents a text caption that describes the first object depicted within the bounding box, where the text caption is of the target length. For example, a bounding box in an image can depict a giraffe eating leaves next to a baseball. If the target length is 5 text tokens and tokens represent words, the caption can read “A giraffe and a baseball”. If the target length is 2, the caption can read “A giraffe” and similarly, if the target length is 3, the caption can read “A giraffe eating”. More generally, however, text tokens can represent any of a variety of units of text, e.g., characters, sub-words, word pieces, byte pairs, and so on. In some examples, the language model neural network can receive multiple different target lengths and process multiple corresponding input sequences to generate multiple captions of the same bounding box of different lengths.

In some implementations, the system can obtain data specifying a location of a second bounding box within the input image that depicts a second object. This data thus specifies a location of a second bounding region encompassed within the second bounding box.

The system can generate a second bounding box embedding vector that represents the location of the second bounding box (alternatively described as the location of the second bounding region).

The system can generate a second input sequence of input embedding vectors that includes the image sequence of image embedding vectors and the second bounding box embedding vector.

The system can process the second input sequence of input embedding vectors using the language model neural network to generate an output sequence of text tokens that represents a text caption that describes the second object depicted within the second bounding box.

Thus, in some examples, the system can generate text captions for multiple bounding boxes within an input image. For example, an image can depict a cat and a dog. The system can receive data specifying a location of a bounding box that includes the cat and a location of a a second bounding box that includes the dog. The system can generate text captions that read “A large cat” and “A small dog” respectively.

In some implementations, the system can receive an input specifying a second target length for the text caption. The system can then generate a second length embedding that represents the second target length. The system can process a third input sequence of input embedding vectors that includes the image sequence of image embedding vectors, the bounding box embedding vector, and the second length embedding that represents the second target length using the language model neural network. The system can generate a second output sequence of text tokens that represents a second text caption that describes the first object depicted within the first bounding box.

For example, an image can depict a coaster on a table. The system can receive a target length of 2 and a second target length of 5 and generate captions that read “A coaster” and “A coaster on a table” respectively.

FIG. 3. is a flow diagram of an example process 300 for jointly training an image encoder neural network and a language model neural network of a caption generation system. For convenience, the process 300 will be described as being performed by a system of one or more computers located in one or more locations. For example, an object detection system, e.g., the caption generation system 100 of FIG. 1, appropriately programmed in accordance with this specification, can perform the process 300.

The system can receive a set of training examples (step 302).

Each training example can include a training input image, a training bounding box (or bounding region), and multiple training captions of different lengths. The input image can depict one or more objects. For instance, an image captured by a camera can show objects such as road signs, vehicles, pedestrians, buildings, etc. As another example, an image captured by a medical imaging device can show anatomical structures (e.g., organs, tumors, etc.), tissues, regions of a human or animal body, etc. The bounding box can be represented as a set of coordinates specifying the location of a bounding box in the input image. Each training caption can be any sequence of text tokens that describes the region of the image in the training bounding box.

The training system can train the caption generation system to generate the next token in a sequence, while accounting for the desired length of the caption. The training loss can be a standard next-word prediction loss that is used to train image captioning models e.g., a classification loss over all the words present in the vocabulary.

The system can jointly train the image encoder neural network and the language model neural network to optimize an objective function. The objective function can measure the performance of the image encoder neural network and the language model neural network on a next token prediction task.

For a given training example, the objective function can maximize the log likelihood

$$l ( X , B , W ) = {\sum }_{i = 1}^{M} log p ( {w}_{i} \vert {w}_{< i} , X , B )$$

where X represents the a training input image, B represents a training bounding box, and W={LENGTH-k, w₁, w₂, . . . , wₖ} and w_{N} represents the caption represented by N text tokens. The overall loss can be calculated as

$$L ( D ) = {\sum }_{j = 1}^{N} l ( {X}_{j} , {B}_{j} , {W}_{j} ) = {\sum }_{j = 1}^{N} {\sum }_{i = 1}^{M} log p ( {( {w}_{j} )}_{i} \vert {( {w}_{j} )}_{< i} , {X}_{j} , {B}_{j} )$$

where D represents the set of training examples, N is the number of training examples in the set of training examples, and M is the fixed maximum size of the text caption.

In some examples, the system jointly trains the linear neural network with the image encoder neural network and the language model neural network.

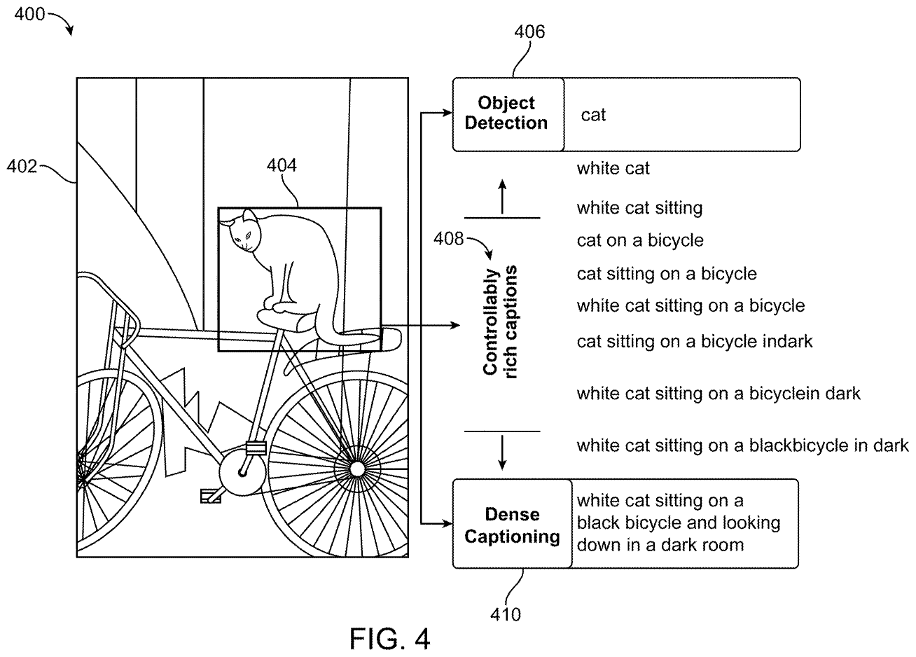

FIG. 4 shows an example 400 of an input image and associated captions generated by a caption generation system. The example shows an input image 402 that includes a bounding box 404 depicting a white cat that is sitting on a bicycle.

For a task of object detection, the caption generation system can generate a caption 406 with a target length of 1 text token that reads “cat”. For a task of dense captioning for the same bounding box 404 in the same input image 402, the caption generation system can generate a caption 410 with a target length of 14 that reads “white cat sitting on a black bicycle and looking down in a dark room”. For various other target lengths, the caption generation system can generate captions 408 of the appropriate lengths. For example, for a target length of 3 the caption can read “white cat sitting”, and for a target length of 6 the caption can read “white cat sitting on a bicycle”.

The caption generation system can produce outputs of a desired length by utilizing length conditioning. The system can generate the different captions by being conditioned on different length embeddings i.e., by using an additional token indicating the desired length of the output caption in the input.

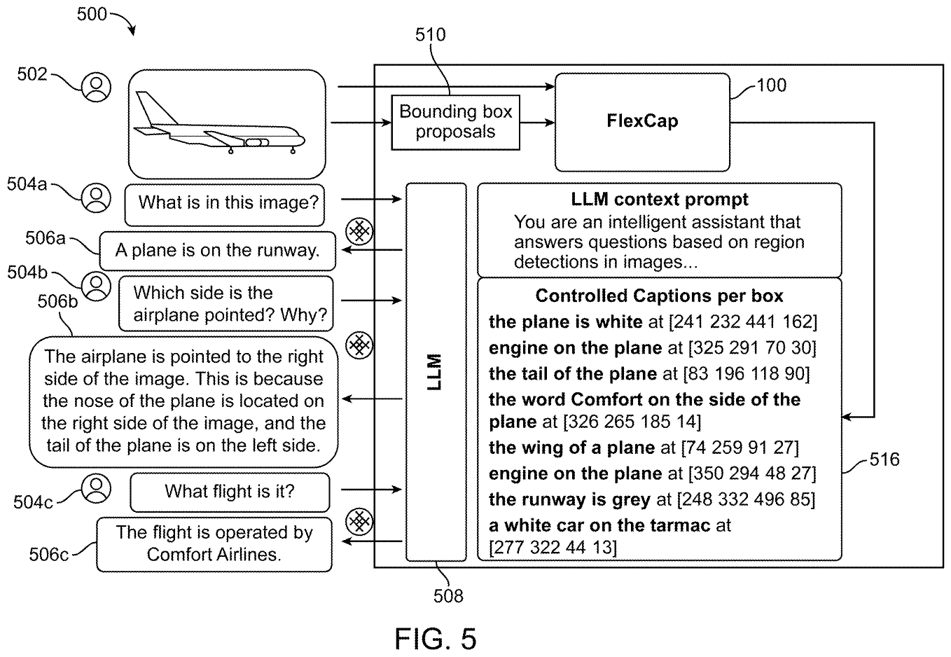

FIG. 5 illustrates an example 500 of a system for performing zero-shot visual question answering.

The system receives an input image 502 that depicts an airplane on a runway. The airplane has text on it that reads “Comfort Airlines”.

The system can convert the input image to a sequence of localized descriptions 516 that describe the input image 502 in terms of the objects and regions present in the image. The system can use the caption generation system 100 to identify the location of proposed bounding boxes within the input image. The caption generation system 100 can include an object detector neural network. The object detector neural network can be, for example, an OWL-ViTv2 that can localize significant objects and regions in an image. The system can have a specified maximum number (e.g., 10, 40, 100, etc.) of bounding boxes to generate captions for.

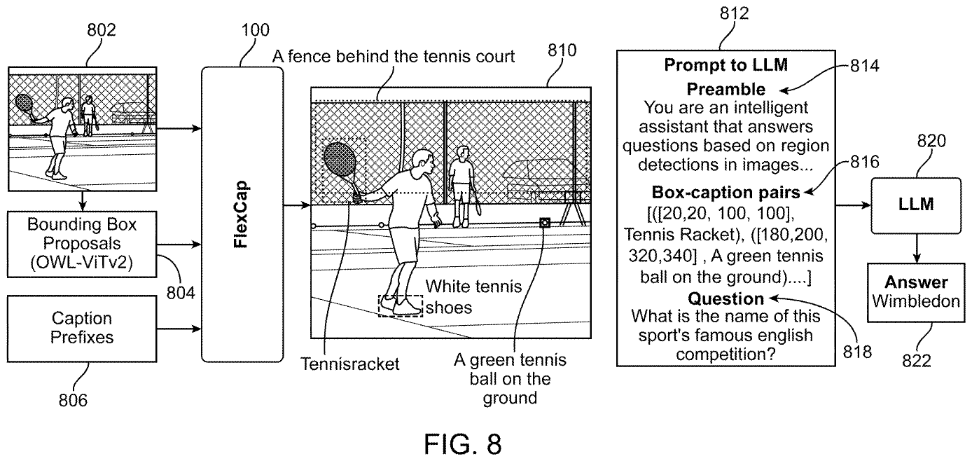

The system can use a caption generation system 512 to describe each bounding box in the input image in the context of the entire input image. In order to produce holistic descriptions, the system can use multiple prefixes for each region. Prefixes for captions are described in further detail below with reference to FIG. 8.

The system can use a large language model 508 to generate responses 506 a-c to text prompts 504 a-c that include questions about the input image. The large language model can use the localized descriptions 516 to generate the responses 506 a-c. The large language model 508 can be, for example, aPALM2-S model.

The localized description 516 can each include a text caption and the location of a bounding box that the text caption describes. For example, a localized description can include “the plane is white” at the location [241 232 441 162]. As another example, a localized description can include “the word Singapore on the side of the plane” at the location [326 265 185 14].

In this example, the questions 504 a-c read “What is in this image?”, “Which side is the airplane pointed? Why?”, “What flight is it?” respectively. The associated responses 506 a-c read “A plane is on the runway”, “The airplane is pointed to the right side of the image. This is because the nose of the plane is located on the right side of the image, and the tail of the plane is on the left side”, and “The flight is operated by Comfort Airlines” respectively. As a particular example, the large language model 508 can use the localized description reading “the word Comfort on the side of the plane” at the location [326 265 185 14] to generate the response 506c “The flight is operated by Comfort Airlines”.

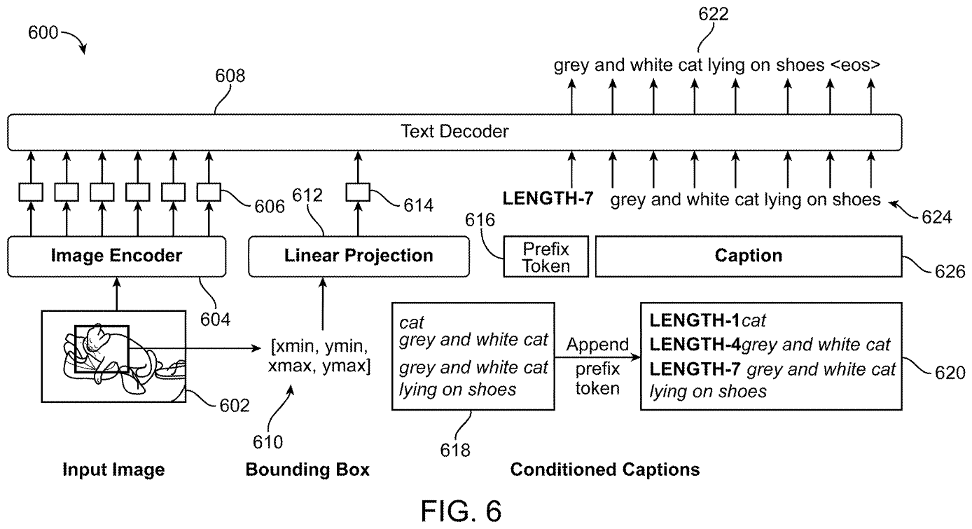

FIG. 6 shows an example 600 of training a caption generation system. For convenience, the training will be described as being performed by a training system.

The training system can receive a training input image 602, a training bounding box 610, and, a set of training captions 618.

The training input image 602 can depict one or more objects. In this example, the training input image depicts a grey and white cat on top of shoes. The training bounding box can be represented as a set of coordinates specifying the location of a bounding box in the input image. In this example, the training bounding box 610 is located in the region of the image that depicts the cat. Each training caption can be any sequence of text tokens that describes the region of the image in the training bounding box. In this example, the training captions 618 include “cat”, “grey and white cat”, and “grey and white cat lying on shoes”.

The training system can use an image encoder neural network to 604 process the training input image 602 to generate an image sequence 606 of image embedding vectors. The image embedding vectors can characterize the training input image 602. One or more of the image embedding vectors can each correspond to a respective object that is shown in the training input image.

The training system can us a linear neural network 612 to process the training bounding box 610 to generate a bounding box embedding vector 614. The bounding box embedding vector 614 can be a one-dimensional vector describing the location of the training bounding box 610 within training the input image 602.

The training system can generate set of appended training captions 620 by adding a prefix to each training caption 618 that indicates the number of text tokens in the caption. In this example, the appended training captions 610 read “LENGTH-1 cat”, “LENGTH-4 grey and white cat”, and “LENGTH-7 grey and white cat lying on shoes”.

For a particular training example, the system can receive a desired length of an output caption. In this example, the desired length is 7.

The training system adds an additional token 616 to the caption 626 indicating the desired length of the output caption to create a prefixed input caption 624. The training system can prefix text tokens with the desired length of the caption and append with an end of sentence token to indicate the end of the caption. The target text tokens are obtained by shifting the padded text by 1. The training system trains the caption generation system on a classification loss over all the words present in the vocabulary. The loss is ignored over the padded tokens that are used to keep the size of the outputs same for all the captions in the batch.

The training system can use a transformer-based text decoder 608 to process the image sequence of image embedding vectors, bounding box embedding vectors, and prefixed input caption 624 to generate a caption 622 of the desired length.

The training system can train the caption generation system to generate the next token in a sequence, while accounting for the desired length of the caption. The training loss can be a standard next-word prediction loss that is used to train image captioning models e.g., a classification loss over all the words present in the vocabulary.

For a given training example, the training system can train the caption generation system to optimize an objective function that maximizes the log likelihood

$$l ( X , B , W ) = {\sum }_{i = 1}^{M} log p ( {w}_{i} \vert {w}_{< i} , X , B )$$

where X represents the a training input image. B represents a training bounding box, and W={LENGTH-k, w₁, w₂, . . . , wₖ} and w_{N} represents the caption represented by N text tokens. The overall loss can be calculated as

$$L ( D ) = {\sum }_{j = 1}^{N} l ( {X}_{j} , {B}_{j} , {W}_{j} ) = {\sum }_{j = 1}^{N} {\sum }_{i = 1}^{M} log p ( {( {w}_{j} )}_{i} \vert {( {w}_{j} )}_{< i} , {X}_{j} , {B}_{j} )$$

where D represents the set of training examples, N is the number of training examples in the set of training examples, and M is the fixed maximum size of the text caption.

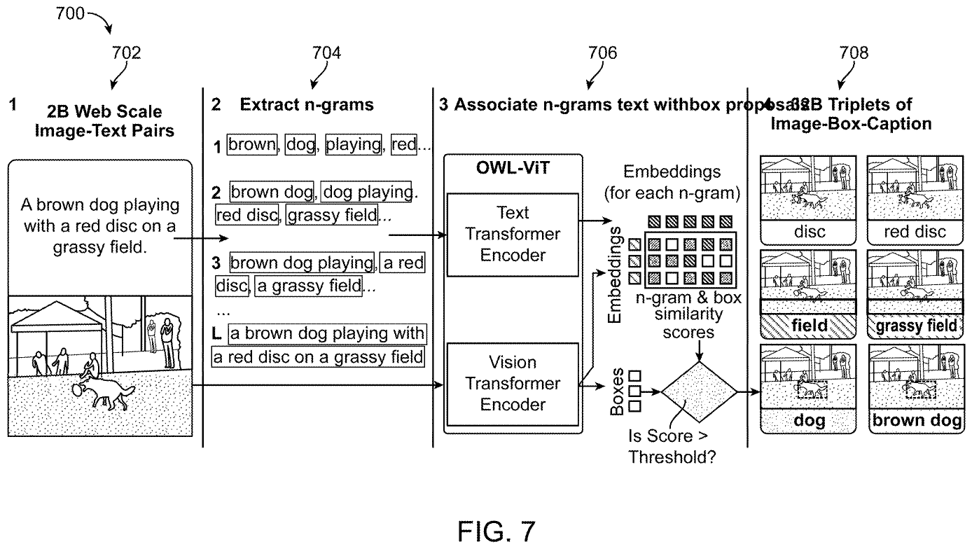

FIG. 7 illustrates an example process 700 for generating a set of training data for a caption generation system. For convenience, the process will be described as being performed by a training system.

The training system can receive image and text pairs (702), where the text is a description of the corresponding image. For a specific image and text pair, for example, the text can read “A brown dog playing with a red disc on a grassy field” and the image can depict a dog playing on a field with a red disc.

The training system can create text queries by extracting n-grams of varying lengths from the text describing the image (704). For example, for the text “A brown dog playing with a red disc on a grassy field”, the system can extract the 1-grams: “brown”, “dog”, “playing”, and “red”, 2-grams: “bown dog”, “dog playing”, “red disc”, “grassy field”, 3: grams. “brown dog playing”, “a red disk”, “a grassy field”, etc. The training system filter out incomplete captions such as “with a red” and “dog playing with”.

The training system can use the filtered n-grams as text queries for a pre-trained region proposal model (706). The pre-trained region proposal model can be, for example, an object detector neural network e.g., OWL-ViT. The training system can use the region proposal model to extract boxes and select text-box pairs based on a similarity score threshold (e.g., greater then 0.1).

The training system can generate multiple captions for each bounding box in the image (708). Multiple n-grams may satisfy a similarity score threshold for a box. For example, a bounding box can be described as both “disk” and “red disk”. The training system can use the image, and corresponding proposed bounding boxes and generated captions to create a training data set for training a caption generation system.

FIG. 8 illustrates another an example system for performing zero-shot visual question answering. The system includes the caption generation system 100 and a large language model 820.

The system can receive an input image 802. In this example, the input image depicts a man playing tennis. The system can process the input image using an object detector neural network 804 to generate bounding boxes in the input image.

The system can use a prefix appending engine 806 to add prefixes to the beginning of generated captions to extract desired properties. For example, the prefixes can include a desired length of the caption. As another example, the prefixes can include a desired preamble to the caption e.g., “this is used for”, “the sign says”, “written by”, etc.

The caption generation system 100 can process the input image 802, the bounding boxes, and the desired prefixes to generate localized descriptions 810 of the input image. For example, the caption generation system can generate a description reading “white tennis shoes” for a bounding box depicting the player's feet and a description reading “Tennis racket” for a bounding box depicting the player's tennis racket.

The system can use the localized descriptions 810 to generate a prompt 812 for large language model 820. The prompt can include a context prompt 814, a set of box-caption pairs 816, and a question 818. The context prompt 814 can be a text preamble that defines a setup for using an large language model to answer questions about an image. The box-caption pairs can each include the coordinates of a bounding box and a caption that describes the region of the image depicted in the associated bounding box e.g., ([20, 20, 100, 200], Tennis Racket). The question 818 can be any question about the input image. In this example the question is “What is the name of this sport's famous competition?”.

The large language model 820 processes the prompt and generates an answer 822 based on the box-caption pairs 816 and the question 818. In this example, the large language model 820 generates an answer of “Wimbledon”.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining an input image;
processing the input image using an image encoder neural network that has been trained to process the input image to generate an image sequence of image embedding vectors characterizing the input image;
obtaining data specifying a location of a first bounding region within the input image that depicts a first object;
generating a bounding region embedding vector that represents the location of the first bounding region;
generating an input sequence of input embedding vectors that includes the image sequence of image embedding vectors and the bounding region embedding vector; and
processing the input sequence of input embedding vectors using a language model neural network to generate as output an output sequence of text tokens that represents a text caption that describes the first object depicted within the first bounding region.

2. The method of claim 1, further comprising:
receiving an input specifying a target length for the text caption; and
generating a length embedding that represents the target length;
wherein the input sequence of input embedding vectors includes (i) the image sequence of image embedding vectors, (ii) the bounding region embedding vector, and (iii) the length embedding that represents the target length.

3. The method of claim 2, wherein the target length is a target number of text tokens for the output sequence of text tokens.

4. The method of claim 1, further comprising:
processing the input image using an object detector neural network to identify the location of the first bounding region within the input image.

5. The method of claim 1, further comprising:
obtaining data specifying a location of a second bounding region within the input image that depicts a second object;
generating a second bounding region embedding vector that represents the location of the second bounding region;
generating a second input sequence of input embedding vectors that includes the image sequence of image embedding vectors and the second bounding region embedding vector; and
processing the second input sequence of input embedding vectors that using the language model neural network to generate as output an output sequence of text tokens that represents a text caption that describes the second object depicted within the second bounding region.

6. The method of claim 1, wherein generating a bounding region embedding vector that represents the location of the first bounding region comprises:
processing the data specifying a location of a first bounding region using a linear neural network to generate a one-dimensional vector describing the location of the first bounding region within the input image.

7. The method of claim 1, wherein the data specifying a location of a first bounding region comprises the coordinates of the first bounding region.

8. The method of claim 1 wherein processing the input image using an image encoder neural network that has been trained to process the input image to generate an image sequence of image embedding vectors characterizing the input image comprises:
generating a set of initial image embedding vectors using an embedding layer of the image encoder neural network, wherein each initial image embedding vector is derived at least in part from a corresponding patch in the input image; and
processing the set of initial image embedding vectors using a plurality of neural network layers, including one or more self-attention neural network layers, to generate a set of final image embedding vectors.

9. The method of claim 1, further comprising:
receiving an input specifying a second target length for the text caption;
generating a second length embedding that represents the second target length; and
processing a third input sequence of input embedding vectors that includes the image sequence of image embedding vectors, the bounding region embedding vector, and the second length embedding that represents the second target length using the language model neural network to generate as output a second output sequence of text tokens that represents a second text caption that describes the first object depicted within the first bounding region.

10. The method of claim 6, wherein the image encoder neural network and the language model neural network are jointly trained to optimize an objective function that measures the performance of the image encoder neural network and the trained language model neural network on a next token prediction task.

11. The method of claim 10, wherein the linear neural network is jointly trained along with the image encoder neural network and the trained language model neural network.

12. The method of claim 1, wherein the language modeling neural network is an auto-regressive Transformer-based neural network comprising a plurality of layers that each apply a self-attention operation.

13. The method of claim 1, wherein the image encoder neural network comprises a convolutional neural network.

14. The method of claim 13, wherein the convolutional neural network is configured to process the input image to generate an output tensor characterizing the input image, and wherein the image encoder neural network is configured to map the output tensor to the image sequence of image embedding vectors.

15. A system comprising:
one or more computers; and
one or more storage devices storing instructions that, when executed by the one or more computers, cause the one or more computers to perform operations comprising:
obtaining an input image;
processing the input image using an image encoder neural network that has been trained to process the input image to generate an image sequence of image embedding vectors characterizing the input image;
obtaining data specifying a location of a first bounding region within the input image that depicts a first object;
generating a bounding region embedding vector that represents the location of the first bounding region;
generating an input sequence of input embedding vectors that includes the image sequence of image embedding vectors and the bounding region embedding vector; and
processing the input sequence of input embedding vectors using a language model neural network to generate as output an output sequence of text tokens that represents a text caption that describes the first object depicted within the first bounding region.

16. One or more computer-readable storage media storing instructions that when executed by one or more computers cause the one or more computers to perform operations comprising:
obtaining an input image;
processing the input image using an image encoder neural network that has been trained to process the input image to generate an image sequence of image embedding vectors characterizing the input image;
obtaining data specifying a location of a first bounding region within the input image that depicts a first object;
generating a bounding region embedding vector that represents the location of the first bounding region;
generating an input sequence of input embedding vectors that includes the image sequence of image embedding vectors and the bounding region embedding vector; and
processing the input sequence of input embedding vectors using a language model neural network to generate as output an output sequence of text tokens that represents a text caption that describes the first object depicted within the first bounding region.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. The system of claim 15, wherein the operations further comprise:
receiving an input specifying a target length for the text caption; and
generating a length embedding that represents the target length;
wherein the input sequence of input embedding vectors includes (i) the image sequence of image embedding vectors, (ii) the bounding region embedding vector, and (iii) the length embedding that represents the target length.

34. The system of claim 16, wherein the target length is a target number of text tokens for the output sequence of text tokens.

35. The system of claim 15, wherein the operations further comprise:
processing the input image using an object detector neural network to identify the location of the first bounding region within the input image.

36. The method of claim 1, wherein the first bounding region is a bounding box.
